(19) United States
(12) Patent Application Publication
(10) Pub. No.: US 2008/0174078 A1
(43) Pub. Date: Jul. 24, 2008

(54) PENDENT LOAD-BEARING DEVICE

(76) Inventor: Michael R. Dooley, Los Altos, CA (US)

Correspondence Address: NUTTER MCCLENNEN & FISH LLP, WORLD TRADE CENTER WEST, 155 SEAPORT BOULEVARD, BOSTON, MA, 02210-2604, US

(21) Appl. No.: 12/015,622

(22) Filed: Jan. 17, 2008

Related U.S. Application Data
(60) Provisional application No. 60/881,014, filed on Jan. 18, 2007.

(51) Int. Cl. B62B 1/00; A45F 4/02; A45F 4/00; A45F 3/10; B62B 5/00

(52) U.S. Cl. 280/1.5; 280/35; 280/47.24; 280/30; 224/153

(57) ABSTRACT

Devices and methods of transporting a load (e.g., a backpack) over surfaces, such as an uneven terrain, are disclosed. In one instance, a frame and harness designed to attach to a standard backpack are disclosed. The device allows a hiker to pull or carry their backpack. In one embodiment, the cart has a frame with one or more wheels mounted at one end, and one or more handles extending beyond the opposite end. While being used to pull the backpack, the cart can be partially suspended by straps connecting the shoulder harness and the handles, thus freeing the hiker's hands without unduly restricting his/her freedom of movement. The cart can also be designed so that an attached backpack may still be carried in the normal fashion without detaching it from the cart. Other features of such devices, and methods relating to the use of load-bearing devices are also disclosed.

### CROSS REFERENCE TO RELATED APPLICATION(S)

The present application claims the benefit of a U.S. Provisional Application bearing Ser. No. 60/881,014, filed Jan. 18, 2007, entitled “Pendent Load-Bearing Cart,” the entire contents of which is hereby incorporated herein by reference.

### FIELD OF THE APPLICATION

The present application relates to methods and devices for aiding transportation of loads such as backpacks, and can particularly relate to such methods and devices which can be adapted for use over varying types of terrain.

### BACKGROUND

Carrying a heavy backpack for long distances can be tiring. Using a cart to pull a backpack requires much less effort if the terrain is relatively smooth. Hiking trails, however, can include sections that are too rough to accommodate a wheeled cart.

Wheeled backpacks have been developed, which can give a hiker the choice of pulling or carrying their load. For example, Talbott, U.S. Pat. No. 2,401,986 discloses a “pack cart of a type adapted to be used as a cart for wheeling a pack over the ground or as a pack frame for carrying a pack on the back”. Strand, U.S. Pat. No. 3,550,997 describes a “mechanism attachable to a backpack and usable for transporting the backpack in a wheelbarrow fashion”.

One common disadvantage of previously disclosed wheeled backpacks is that they require the constant use of one or both of the operator's hands to support and pull them. This makes the devices uncomfortable to pull for extended periods of time, thus defeating their main purpose.

Others have disclosed carts which incorporate a waist or shoulder harness to allow them to be pulled without requiring the use of the operator's hands. For example, Cordova, U.S. Pat. No. 5,769,431 describes “A backpack and load conveyance apparatus” with a “backpack shoulder and waist support assembly”. Hamblin, U.S. Pat. No. 6,039,333 discloses “a two wheeled cart for transporting supplies over a trail and other outdoor terrain” with “a body harness attached to the frame”. Purpuro, U.S. Pat. No. 6,935,643 describes a wheeled cart which incorporates “a belt fastenable about a user's waist” for pulling the device.

But none of these devices are suitable as a backpacker's aid since they are only designed to be pulled, and would be difficult to carry over rough terrain. Another common problem with these designs is that they all specify a tight coupling between the cart and user. This can be impractical when traveling on rough terrain because the hiker must be able to move somewhat independently from the cart or risk being thrown of balance by it. Even on smooth terrain a tight coupling between a cart and hiker can lead to uncomfortable and destabilizing oscillations between the hiker and cart.

Therefore, a need exists for devices and methods to improve transport of a backpack device over uneven terrain.

### SUMMARY

In accordance with one embodiment a pendent backpack cart comprises a shoulder harness and a light weight cart which can accommodate a standard backpack. The cart, which can have a trapezoidal frame, can have one or more wheels mounted on one edge and a pair of optionally adjustable handles (e.g., removable and/or collapsible) extending beyond the opposite edge. The cart can be pulled along by a person while suspended from the harness (e.g., by the use of one of more straps) without the use of the person's hands. The distance between the harness and the frame can be adjusted. The cart can also be adapted to allow significant movement in any direction between the person and the frame. The cart can also be carried while attached to the backpack. The cart can include means for attaching the backpack to the cart, and/or means to prevent the backpack from contacting the wheel(s) of the cart. The harness can included padded loops adapted to fit over the shoulders, and or a chest strap that can include a clasp for adjusting the strap. The cart can also include a means for protecting the backpack from moisture and/or dirt (e.g., a protective shell).

Another embodiment is directed to a device such as a load-bearing device (e.g., a cart) for pulling a backpack over even or uneven terrain. The device can include a frame (e.g., a trapezoidal frame), which can be adapted to removeably coupled to a backpack, having one or more wheels toward one end. One or more handles can be optionally located at an opposite end of the frame. A handle can be adapted to be collapsible, e.g., retractable within the frame of the device. The frame can be lightweight (e.g., less than about 30 pounds, or less than about 25 pounds, or less than about 20 pounds), and can be adapted to be removeably attached to a backpack, while the backpack is worn in the typical fashion by a user. The device can also include a harness (e.g., a shoulder harness) adapted to be worn by a person. The harness can include one or more flexible couplers, which can be optionally adjustable in length, adapted to be removeably attached to the frame. In some embodiments, a slideable retainer is coupled to the frame for securing a flexible coupler with the frame. The device can be adapted to pull a backpack coupled to the frame using the at least one handle and/or the at least one flexible coupler. For example, the flexible coupler(s) can be adapted to allow the frame to undulate as it is pulled without upsetting the balance of the person pulling the frame. A flexible coupler can also include a shock absorbing mechanism in some instances. The frame can include other features such as a pack support structure for hindering a pack from sliding off the frame, and/or a shell to protect the coupled backpack from dirt or other debris, and/or to keep portions of the backpack from contacting the ground while being pulled on the frame.

Another embodiment is directed to a method of transporting a backpack. The method includes providing a frame with at least one wheel for supporting the backpack. The frame can include any of the features described in the present application. The method further includes pulling the frame using at least one flexible strap coupled to a person. The frame and strap can be adapted to allow a person to pull the frame without using hands. The strap can have a length sufficient to allow the frame to undulate, e.g., while being pulled, without imparting substantial force on the person. The frame can also be pulled by a handle. A backpack can be worn in the typical fashion while being attached to the frame.

Accordingly, some embodiments are adapted to provide a device which is easily configured for user's of different sizes, and adjustable while being used. The device can be easily transported and stored. As well, manufacturing can be relatively simple and/or inexpensive.

### BRIEF DESCRIPTION OF THE DRAWINGS

Aspects of the present application can be more fully understood from the following detailed description taken in conjunction with the accompanying drawings (not necessarily to scale), in which:

FIG. 1 is a perspective view of a pendent backpack cart in accord with some embodiments of the invention;

FIG. 2 is a perspective view of a hiker pulling the pendent backpack cart of FIG. 1 with an attached backpack;

FIG. 3 is a perspective view of a hiker carrying a backpack with the attached backpack cart of FIG. 1 with handles collapsed;

FIG. 4 is a detailed view of the connection between the harness and the frame handle in accord with some embodiments of the invention;

FIG. 5 is a detailed view of a frame showing handle positioning holes and spring loaded pin consistent with some embodiments of the invention;

FIG. 6 is a detailed view of the frame and the right wheel, in accord with some embodiments of the invention;

FIG. 7 is a perspective view of another load-bearing device consistent with some embodiments of the present invention; and

FIG. 8 is a detailed cross-sectional view of a frame handle, in accord with some embodiments of the invention.

### DETAILED DESCRIPTION

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with any number of features of any other embodiment(s). For example, if one embodiment is drawn to a cart having a trapezoidal frame, and another embodiment is drawn to an embodiment with a frame and one wheel, other embodiments can include carts having a trapezoidal frame with one wheel. All such modifications and variations are intended to be included within the scope of the present invention.

Some embodiments are directed to methods and devices for transporting a payload, such as a backpack. In some embodiments, a load-bearing device is provided that can be a cart. The device includes a frame which can be removeably coupled to a backpack, e.g., in a manner such that the backpack can be worn as it is typically designed with the cart attached thereto. The device can have one or more wheels, which can be disposed toward an end of the cart. A harness can also be provided to be worn by an operator, e.g., a shoulder harness which can optionally have padded loops. The harness can include one or more flexible couplers for attaching the frame to the person wearing the harness. A flexible coupler, which can optionally be removeably coupled to the frame, can be adapted to allow the person to pull the device along the ground without any further support structures. The flexible couplers can allow the cart to undulate as the device is rolled over uneven terrain without upsetting the balance of the person pulling the cart, such as could occur with poles or other rigid and/or non-flexible couplers as utilized in some prior art devices. The frame can optionally include one or more handles for pulling the cart—which can allow the device to handle terrain which may be less suitable for pulling solely by a flexible coupler. Such handles can be collapsible into the frame in some embodiments. Related methods are also disclosed herein. Accordingly, some embodiments of the present invention can enable a backpack to be transported more easily over various types of terrain—including undulating and/or rough surfaces—either by pulling or carrying. Such embodiments can help reduce the restriction of a hiker's freedom of movement.

In general, the term backpack has its normal definition to one skilled in the art. In some embodiments, the backpack can be a standard hiker's backpack that is typically used when going backcountry hiking. Such pack's typically have a pair of shoulder harnesses for allowing a user to carry the backpack. In some embodiments, the backpack that can be coupled to a load-bearing device can have a capacity of about 2000 in³ to about 5000 in³.

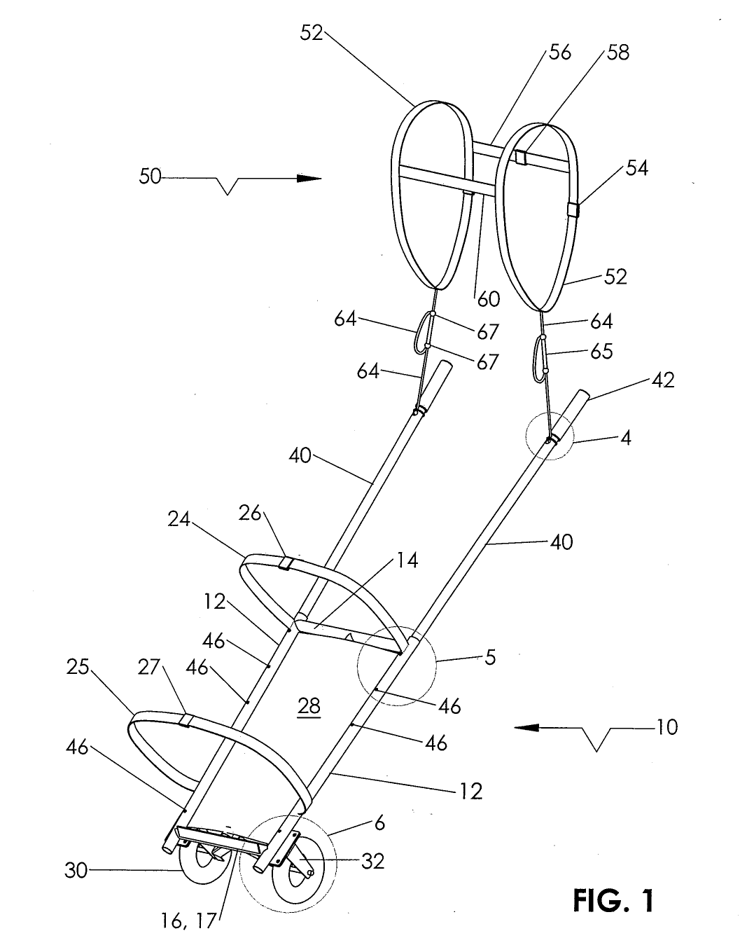

Some embodiments of a load-bearing device include one or more of the features of a device as illustrated in FIG. 1. The illustrated pendent backpack cart in FIG. 1 has a frame 10 and a harness, which is exemplified by a shoulder harness 50. The shoulder harness 50 includes flexible couplers exemplified as cords 64 for removeable coupling with the frame 10. The illustrated embodiment allows the frame, which is configured to carry a hiker's backpack, to pull the frame and backpack along with the support of the cords 64 only. The cords 64 can allow the wheeled frame 10 to undulate over uneven terrain while not substantially imparting force to the user wearing the straps 52 of the shoulder harness 50.

A frame, as utilized by many of the embodiments disclosed in the present application such as the illustrated device of FIG. 1, can be made of some type of lightweight material (e.g., aluminum tubes) so as to have minimal weight and suitable strength. Other non-limiting examples of potential materials include wood, plastic, carbon fiber composite or some combination thereof. Though a weight restriction is not necessary in all instances, in some embodiments the entire device (or the frame portion) has a total weight less than about 30 pounds, or less than about 25 pounds, or less than about 20 pounds, or less than about 15 pounds, or less than about 10 pounds. Accordingly, a lightweight device can allow the backpack and device to be carried by a hiker simultaneously without much more burden than carrying the backpack alone. This can help facilitate a hiker in carrying the frame when the backpack is not being towed with the frame portion. The frame 10 can be partially suspended from a harness, such as the shoulder harness 50, by at least one flexible coupler such as the connecting cords 64.

In some embodiments, a pendent backpack cart can have left-right symmetry, so there are a number of equivalent left and right parts—as exemplified in the device of FIG. 1. For simplicity, equivalent left and right parts are referred to by the same part number. For example both the left and right connecting straps are labeled as connecting straps 64. It is understood that such symmetry is not a necessary feature of devices consistent with some embodiments herein.

In some embodiments, a frame of a cart or other load-bearing device can have a trapezoidal shape. For example, as shown in FIG. 1, the frame portion 10 can be trapezoidal, having an upper-edge member 14, two side-edge members 12, and a lower-edge member 16. The frame 10 can also have one or more internal members 18 spanning the frame and intersecting the upper-edge member 14 and the lower-edge member 16, which can act to reinforce the frame 10. In some embodiments, the width of the frame 10 can be comparable to the width of a standard backpack, which can allow negotiation of narrow trails.

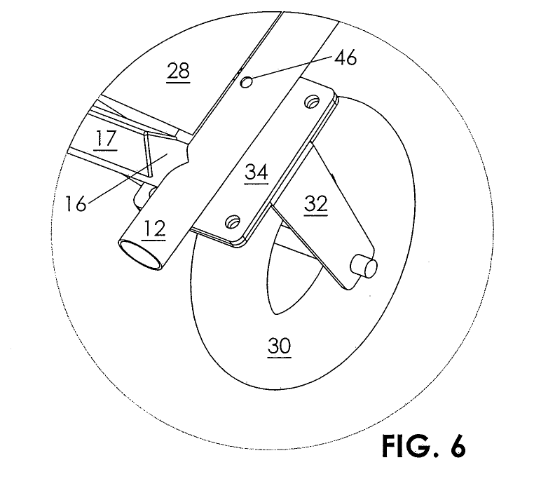

Some embodiments utilize a frame having at least one wheel to allow the frame to be rolled along a surface. For example, as shown in FIG. 1, a frame 10 can have 2 wheels 30 for balancing the frame 10 as it is pulled. In some embodiments, the at least one wheel can be disposed toward one end of the frame, which can allow the frame to be supported by the wheel(s) and a handle 42 and/or cord 64 as exemplified in FIG. 1. Accordingly, some embodiments allow the device to have good maneuverability, allowing easy negotiation of sharp turns in a trail. The wheel(s) of a frame can be standard pneumatic wheels such as found on a jogging stroller or a child's bicycle, or any other suitable wheel. In the embodiment shown in FIGS. 1-3 and 6, the wheels 30 are standard caster type wheels.

The wheel(s) can be coupled with the remainder of the frame using any number of suitable techniques, including those known to one skilled in the art. For example, as exemplified in FIGS. 1-3 and 6, the frame 10 can have wheel support mounting plates 34 which can be attached to the bottom side of the lower-edge member 16 and the side-edge members 12 of the frame 10. The wheels 30 can be mounted in standard brackets 32, which can be attached to the frame 10 by bolting to mounting plates 34. In another example, a frame can also have an axel which is parallel to the upper and lower-edge members 14 and 16 and connects the bottom ends of the two side-edge members 12. In some embodiments, the frame and at least one wheel can be configured to have high-ground clearance so that carrying the device is only necessary on very rough terrain, such as while fording a stream or scrambling over large boulders.

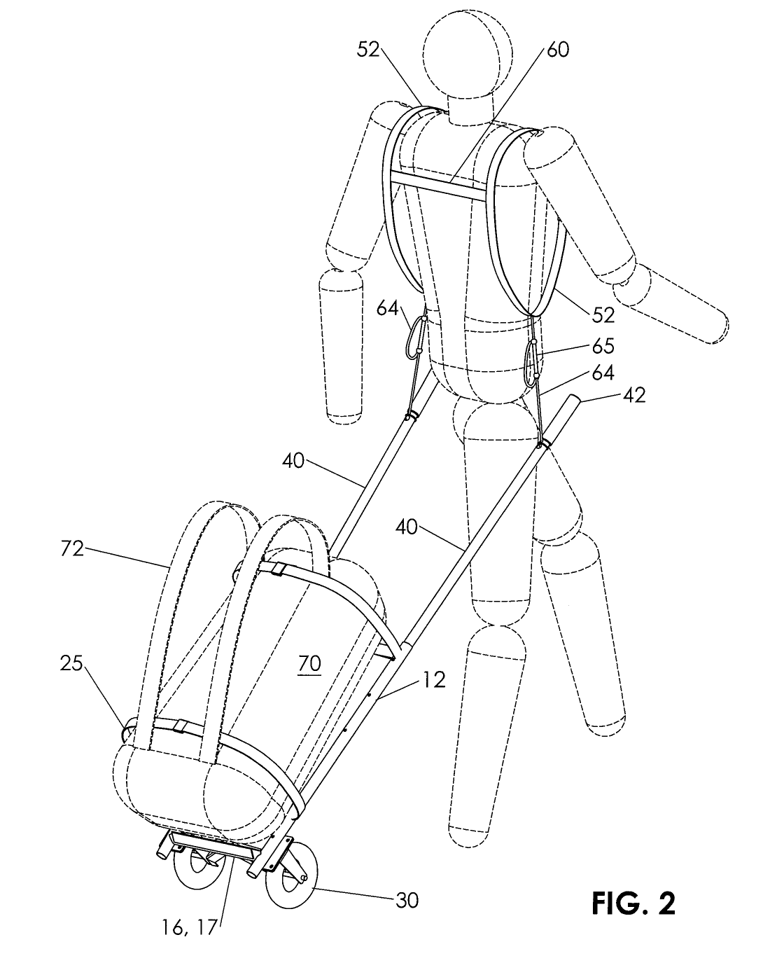

As exemplified in FIGS. 1 and 2, a frame can have include one or more straps 24, 25 for attaching a backpack 72 to the frame 10. The upper pair of straps 24 can be adapted to have left and right sections whose ends can be joined by clasp 26. The other end of the left/right section of the upper strap 24 can attach to the left/right frame side-edge members 12 near the upper-edge member 14. Similarly the lower pair of straps 25 can be joined by clasp 27 and attach to the frame side-edge members 12 but near the lower-edge member 16. The straps 24 and 25 can be made of ½″ or ¾″ nylon webbing. The clasps 26 and 27 could be standard plastic buckles such as the ITW Nexus SR 5/8 101-0063.

In some embodiments, a frame can include a pack support structure. The pack support structure can be disposed toward the end the end of the frame having one or more wheels. Such a structure can act to hinder an attached backpack from sliding off the frame, when the frame is tilted while being pulled. An example of a pack support structure is shown in FIGS. 1, 2, and 6. As illustrated by FIG. 1, the frame 10 can have one or more pack support members 17 protruding above the plane of the frame portion 10. The pack support member 17 can be attached to the lower-edge member 16 as shown in FIGS. 1, 2, and 6.

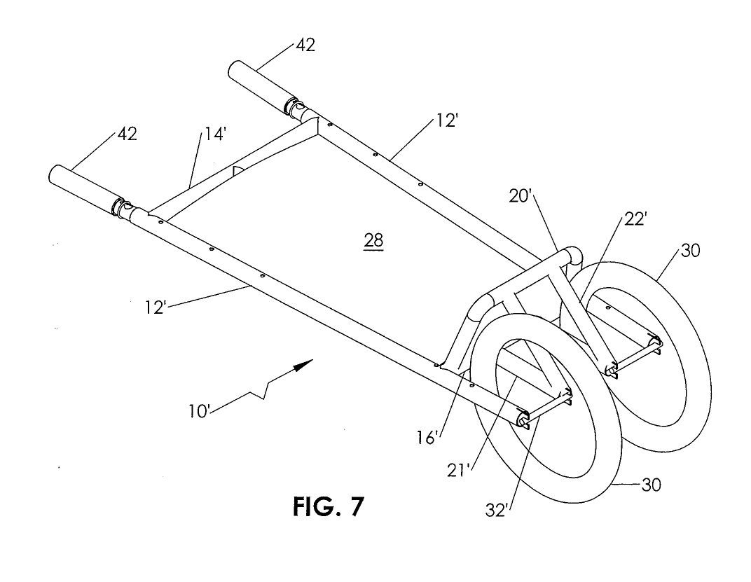

In other embodiments, the pack support structure can be an integral portion of the frame of a cart, and can be adapted to hinder the backpack from sliding off the frame, as shown in FIG. 7. The frame can also have a ‘U’ shaped pack support member 20′, pack support bracing members 22′ and axel support members 21′ to support an axel 32′ as shown in FIG. 7. Together the pack support member 20′, support bracing members 22′ and the axel support members 21′ can form a triangular protrusion from the plane defined by the upper-edge member 14′, the side-edge members 12′ and the lower-edge member 16′. This protrusion can prevent an attached backpack from sliding down the upper side of frame and rubbing against the wheels and provide structural support for the frame 10′ and wheels 30.

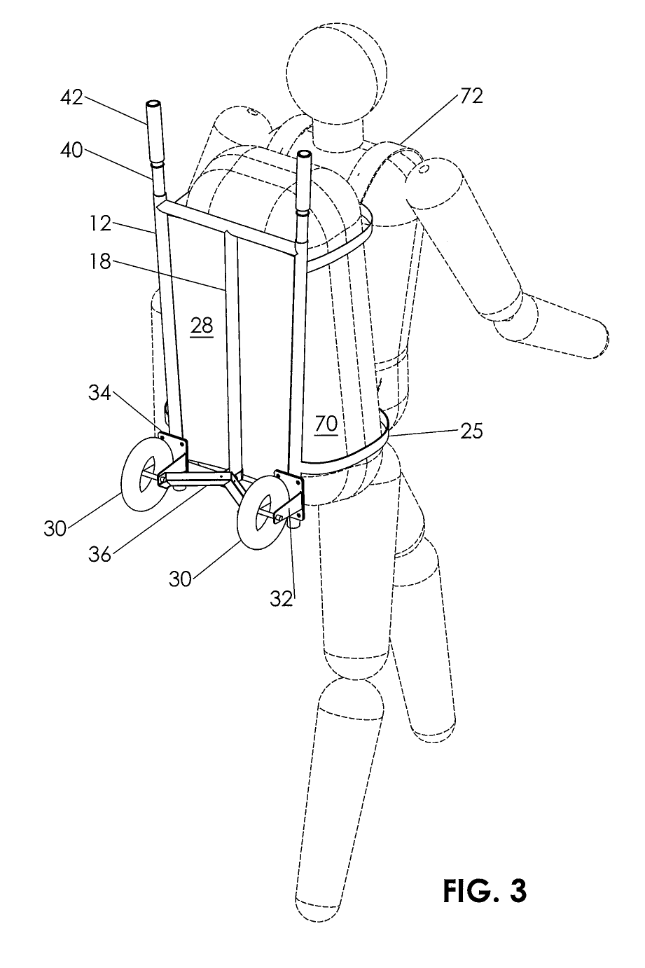

In some embodiments, a frame of a cart or other load-bearing device can include a shell coupled thereto. The shell can be positioned to be interposed between a carried backpack and the ground when a cart is being pulled along the ground. As exemplified in FIGS. 1 and 3, the frame 10 is coupled to a shell 28 attached to the upper side of the frame 10. The shell 28 can protect the backpack from moisture and dirt while being pulled. The shell 28 can also be configured to hinder the straps of the backpack from dragging on the ground while the load bearing device is being pulled. The shell 28 can be constructed with a flexible plastic sheet or heavy duty fabric, and may be attached to the frame in a number of different ways, including Velcro straps, cable ties, small cords, or plastic rivets such as the ITW Fastex 201-100841-00.

In some embodiments, a frame of a load-bearing device can include one or more handles, which can be adapted to pull the device along the ground with or without the use of a harness. Such handles can provide several potential advantages such as allowing damping of large oscillations by the wheeled portion of the device, or additional stability to prevent device tipping on extremely rough terrain. The handle(s) can be adapted to be rigid structure(s) for allowing ease of manipulation of the frame by an operator. The handle(s), in some instances, can be collapsible (e.g., folded in one or more places or retractable into a portion of the frame) to allow ease of carrying the backpack and device on the back of an operator.

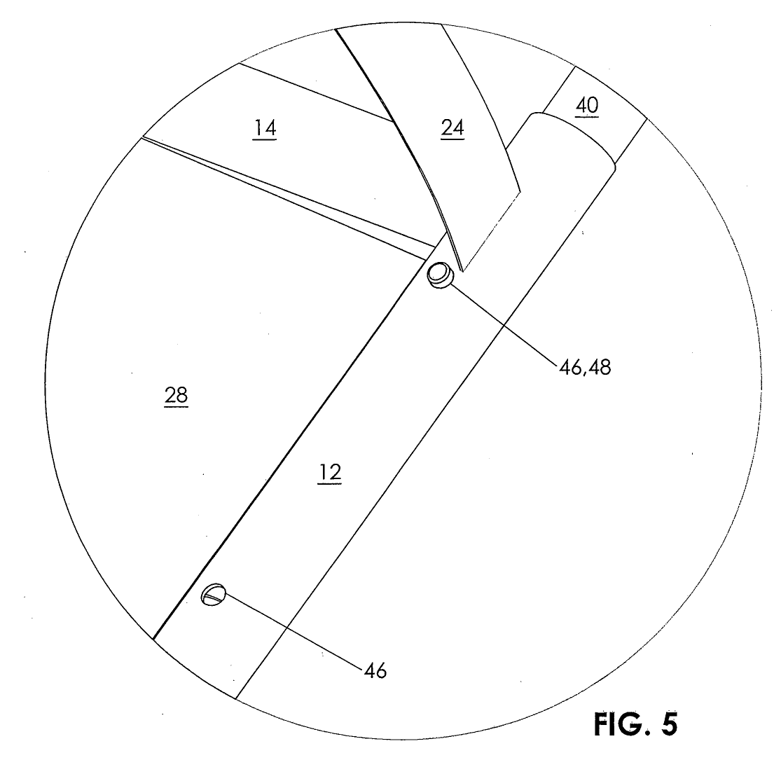

Some exemplary features are shown with respect to FIGS. 1-3 and 5. As illustrated, a frame 10 can have two handles 40 which extend beyond the upper-edge member 14. The handles 40 can be tubes having an outside diameter that is just smaller than the inside diameter of the frame side-edge members 12, thus allowing the handles 40 to collapse (e.g., slide) inside of the frame side-edge members 12. A spring loaded pin 48 can protrude through a hole in the frame handles 40 and any one of a number of holes 46 in the frame side-edge members 12 as shown in FIGS. 1 and 5. The length of each handle 40 may be adjusted by changing which hole 46 in the frame side-edge member 12 the pin 48 protrudes through. Also the handles 40 can be collapsed by depressing the pin 48 and sliding the handles 40 as far as possible into the frame side-edge members 12. The handles 40 can optionally include also hand grips 42 on their ends. These handgrips 42 can be standard bicycle handgrips, for example.

As described herein, a load-bearing cart can include a harness. A harness can be shaped and sized in any manner that can allow a person to wear the harness such that a wheeled frame can be pulled along the ground by coupling the frame to the harness. Accordingly, a harness can take on a variety of configurations including waist bands, shoulder harnesses, rigid padded shoulder hooks, a single piece yoke, and/or any other coupling to a person that allows effective functionality—including those known to one skilled in the art. In some embodiments, a harness of a load-bearing device includes a shoulder harness, which can be adapted to be worn on the torso of an operator. Such a harness can be adapted to enhance the comfort of a person using the harness while operating the device, e.g., distributing the pulling force around the torso of an operator. As well, the shoulder harness can be adapted for ease in allowing a person to wear or remove the harness.

Some features of a shoulder harness are exemplified by the illustrations in FIGS. 1 and 2. The shoulder harness 50 as shown in FIG. 1 can be similar to a standard backpack harness. The shoulder harness 50 includes a pair of harness loops 52 whose upper portion can contain a padded section where they rest on the hiker's shoulders. The front of the two harness loops 52 can be optionally connected by a chest strap 56. The chest strap 56 can have left and right sections which can be joined or detached and tightened by clasp 58. The harness loops 52 can be constructed with any type of material such as foam rubber and/or nylon fabric. For example, standard 1″ nylon webbing can be used for the shoulder portions and a chest strap can be 1″ or ¾″ nylon webbing. The clasp 58 can be a standard plastic buckle such as ITW Nexus SR 5/8 101-0063 and the buckles 70 could be a standard length-adjusting buckle such as the ITW Nexus LL 1 104-0100. The back of the harness loops 52 can also optionally be connected by a piece of fabric or strap 60. This connecting strap 60 and part of the harness loops 52 can be reinforced with a semi-rigid material to help the harness hold its shape and prevent tangling when not being worn.

In some embodiments, a harness of a load-bearing device can include at least one flexible coupler. A flexible coupler can be adapted to be allow the harness to pull a wheeled frame, while changing its conformation in one or more dimensions. In some embodiments, a flexible coupler can be any structure capable of allowing a wheeled frame to undulate to some degree (e.g., over uneven terrain) while not imparting substantial force to a harness-wearing user (e.g., such as to upset the balance of a hiker pulling the wheeled frame with a backpack coupled thereto). Examples of flexible couplers include cords, straps, chains, and other conformation changing structures that can change in one or more dimensions to help conform with the movement of a wheeled frame over undulating surfaces. A flexible coupler can include a shock absorbing mechanism—for example a section of elastic material (e.g., bungee cord) and/or a spring or other elastic mechanism—to help further reduce possible force transmission. In some embodiments, a flexible coupler can be adapted to allow removeable coupling of the frame to a harness, which can allow an operator to easily change from pulling a frame coupled backpack to wearing the frame coupled backpack using the backpack's carrying straps.

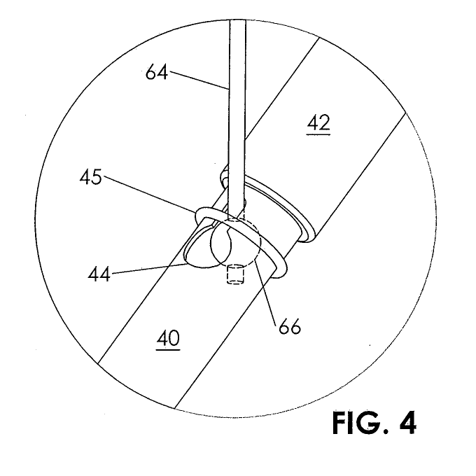

Some features of a flexible coupler of a harness are exemplified in FIGS. 1 and 2. As illustrated, flexible couplers can be embodied as left and right connecting cords 64 which can connect the harness 50 to the left and right frame handles 40 of the frame 10. The upper end of the left/right connecting cord 64 can attach to a standard ‘D’ or triangle connector (not shown) on the left/right harness loop 52. The lower end of the left/right connecting cord 64 can have a knot or stopper 66 which can be inserted into a slotted hole 44 in the left/right frame handle 40, as shown in FIG. 4. The connecting cords 64 can be prevented from slipping out of the slotted hole 44 by sliding retainer rings 45 up against the connecting cords 64. This type of mechanism can be advantageous as it allows a convenient securing mechanism that is easily manufactured and less complex and/or cumbersome than other devices (e.g., hooks or spring-loaded couplers which can break or snag on a backpack or other portions of the device). The connecting cords 64 can utilize standard 3 mm Perlon cord. The connecting cords 64 can also incorporate a shock absorbing mechanism. The shock absorbing mechanism can be an elastic cord or spring 65 that is attached to the connecting cord 64 by knots or clamps 67. Under normal tension, the section of connecting cord 64 between the knots or clamps 67 can be slack, and the entire load is supported by the elastic cord or spring 65. The retainer rings 45 can be standard rubber ‘O’ rings. It is understood that any number of other types of connections (e.g., hooks, clips, and other mechanical attachment devices) can be used in conjunction with a flexible coupler to allow attachment to a frame and/or other portion of a harness.

### Methods and Use Relating to a Load-Bearing Cart

Some embodiments of the invention are drawn to methods of transporting a backpack, such as a hiker's backpack. A device can be provided that aids in the transporting of the backpack. The device can include a frame for supporting and/or coupling to the backpack. The device can be any suitably configured device, which can include any device having one or more features of the carts and/or load-bearing devices described in the present application. The frame, with the coupled backpack, can be pulled using one or more flexible couplers for coupling to a person. A flexible coupler can be adapted to allow a person to pull the frame without using hands, and/or adapted to allow the frame to undulate while being pulled. The frame could also be pulled by using one or more handles attached to the frame. Such undulation can be such that a substantial force is not imparted to the person pulling the frame. The backpack and frame can also be transported by an operator wearing the backpack as it is normally utilized, with the frame attached thereto. The frame can be attached to the backpack in a substantially similar manner as it is attached when the frame is being pulled along terrain by the user.

Use of some features of the illustrated embodiments are described herein with reference to FIGS. 1-3. To load a backpack (e.g., a standard hiker's backpack having a capacity of, for example, about 2000 in³ to about 5000 in³) onto the pendent backpack cart, the backpack 70 can be placed on the frame 10 with the backpack's carrying straps facing away from the frame shell 28 and with its bottom side resting on or above the pack support member 20, thus leaving the backpack shoulder straps 72 and the body facing side of the backpack accessible. The backpack 70 can then be secured to the frame 10 by attaching and tightening the pack straps 24 and 25 as shown in FIG. 2.

To prepare to pull the loaded backpack cart a hiker can put on the shoulder harness by detaching the shoulder harness chest strap clasp 56, placing his/her arms through the shoulder harness loops 52 so that the chest strap 56 is in front and back strap 60 is in back and re-attach the chest strap clasp 56. Next the hiker can stand between the frame handles 40 with his/her back to the cart, pick up the handles 40, insert the connection cord knots 66 into the slotted holes 44 in the handles 40 and slide the retainer rings 45 up against the connecting cords 64. This configuration is shown in FIG. 2 and FIG. 4. In this configuration the hiker can pull the cart on smooth terrain without having to touch the handles, on rough terrain he/she can prevent the cart from tipping by holding the handles. Since the hiker is only tethered to the cart by the connecting cords 64 it is unlikely that he/she will be thrown off balance by the cart as it is pulled over rough terrain. Transporting a backpack in this way can require much less effort than carrying a backpack in the normal manner because only a fraction of the backpack's weight rests on the hiker's shoulders.

The distance between the harness loops 52 and the frame's main body (i.e., the portion without the handles) can be adjusted by any number of mechanisms. For example, the connecting cords 64 can be adapted to have an adjustable length. In another example, the handles 40 can be configured to adjust their length. For the illustrated embodiments, the shoulder harness loops 52 can be shortened by pulling the ends of the harness loops 52 through the adjustment buckles 54 and lengthened by lifting up on the adjustment buckles 54 and allowing the harness loops 52 to slip back through the buckles 54. Adjusting the length of the harness loops 52 has a number of effects on the performance of the pendent backpack cart. Shortening the harness loops 52 lightens the load on the hiker's shoulders by increasing the angle of the frame and shifting more of the weight onto the wheels 30. Lengthening the harness loops 52 on the other hand allows the cart wheels 30 to move further from the hiker's feet so that he/she can take longer strides. Of course the hiker can also temporarily change the position of the cart frame 10 by grabbing the handles 40 and pushing them back, pulling them forward, lifting or twisting them as needed. By having an adjustable length between the wheels and the person pulling a load bearing device, adequate foot clearance can be provided to allow a hiker to freely adjust his stride length without contacting the frame.

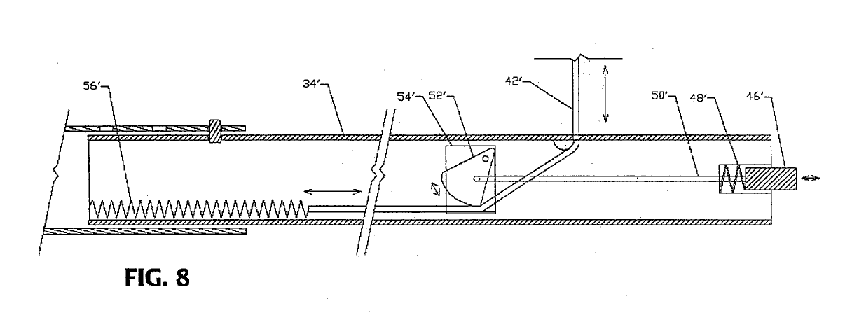

FIG. 8 shows an alternate technique for adjusting the distance between the harness and the frame handles. This variation can eliminate the need for a connecting strap adjustment buckle and instead uses a retractable cord 42′ to connect the shoulder harness loops 52 to the frame handles 40. One end the retractable cord 42′ is attached to the shoulder harness loops 52 and the other end is attached to a tension spring 56′ inside of the frame handle 34′. The retractable cord 42′ is held in place by clamping it between a cam 52′ and cam housing 54′. The cam housing 54′ is attached to the frame handle 34′. The cam 52′ is connected to a cord release button 46′ by a rod 50′. A compression spring 48′ causes the cam 52′ to pivot forward thus locking the cord 42′. Depressing the cord release button 46′ causes the rod 50′ to rotate the cam 52′ backwards, thus allowing the cord 42′ to be extended or retracted. The functional advantage of the retractable cord 42′ over the connecting strap adjustment buckle is that it allows the hiker to adjust the distance between the shoulder harness loops 52 and the frame handles 40 without removing his/her hands from the frame handles.

To switch from pulling to carrying mode, the hiker can disconnect the shoulder harness 50 from the frame handles 40 by sliding the retainer rings 45 down the frame handles 40 and removing the connecting cords 64 from the slotted holes 44 in the frame handles 40. He/she can then collapse the frame handles 40 and lift the backpack 70 onto his/her back as shown in FIG. 3.

Thus the embodiments of a load bearing device, and associated methods, as described above can provide a more efficient and comfortable way to transport a backpack over all types of terrain.

### EQUIVALENTS

One skilled in the art will appreciate further features and advantages of the invention based on the described and/or illustrated embodiments. For example, it is understood that any number of other features can be added to a load-bearing device to facilitate its use as a hiking cart such as an odometer, a braking system, or quick release, or otherwise adjustable, wheels. Accordingly, the invention is not to be limited by what has been particularly shown and described, except as indicated by the appended claims.

All publications and references are herein expressly incorporated by reference in their entirety. The terms “a” and “an” can be used interchangeably, and are equivalent to the phrase “one or more” as utilized in the present application. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

What is claimed is:

1. A device for pulling a backpack, comprising:
a frame including at least one wheel disposed toward one end of the frame and at least one handle toward an opposed end of the frame, the frame adapted to hold a backpack; and
a harness adapted to be worn by a person, the harness including at least one flexible coupler, the at least one flexible coupler configured to be removeably attached to the frame,
the harness and frame adapted to allow a person to pull a backpack coupled to the frame using the at least one handle or the at least one flexible coupler.

2. The device of claim 1, wherein the harness and frame are configured to allow the person to pull the backpack coupled to the frame without using the at least one handle.

3. The device of claim 1, wherein the at least one flexible coupler is adapted to have an adjustable length for varying the distance between the frame and a person wearing the harness.

4. The device of claim 1, wherein the harness comprises a shoulder harness.

5. The device of claim 1, wherein the at least one flexible coupler is adapted to allow the frame to undulate without upsetting balance of the person pulling the backpack coupled to the frame.

6. The device of claim 1, wherein the at least one flexible coupler comprises at least one of a strap, a cord, and a chain.

7. The device of claim 1, wherein the at least one flexible coupler comprises a shock absorbing mechanism.

8. The device of claim 1, wherein the device is adapted to be removeably attached to the backpack.

9. The device of claim 1, wherein the at least one handle includes an adjustable extension configured to vary a distance between the at least one wheel and the at least one handle.

10. The device of claim 8, wherein the adjustable extension is collapsible within the frame.

11. The device of claim 1, wherein the frame is configured such that the backpack can be normally worn by the person while the frame is attached to the backpack.

12. The device of claim 1, wherein the at least one wheel is configured to be positioned on a side of the backpack opposite a side having shoulder straps.

13. The device of claim 1, wherein the frame comprises a pack support structure coupled at the one end of the frame and configured to hinder the backpack from sliding off the frame.

14. The device of claim 1, further comprising:
a slideable retainer coupled to the frame and configured to secure an attached flexible coupler to the frame.

15. The device of claim 1, further comprising:
a shell coupled to the frame and adapted to be interposed between the backpack and ground when the frame is supported by the at least one wheel.

16. A method of transporting a backpack, comprising:
providing a frame having at least one wheel, the frame supporting the backpack;
pulling the frame using at least one flexible couplers coupled to a person, the at least one strap and frame adapted to allow a person to pull the frame without using hands, the at least one flexible strap having sufficient length to allow the frame to undulate without imparting substantial force on the person.

17. The method of claim 16, wherein the frame includes at least one handle, the method further comprising:
pulling the frame using the at least one handle.

18. The method of claim 16, further comprising:
wearing the backpack on shoulders of the person while the backpack is coupled to the frame.

19. A cart for carrying a backpack, comprising:
a frame including at least two wheels disposed toward one end of the frame, the frame adapted to hold a backpack; and
a shoulder harness adapted to be worn by a person, the shoulder harness including at least one flexible coupler, the at least one flexible coupler configured to be removeably attached to the frame, the shoulder harness and frame adapted to allow a person to pull a backpack coupled to the frame using the at least one flexible coupler.

20. The cart of claim 19, wherein the frame further comprises at least two handles for pulling the cart, the at least two handles coupled to an end of the frame opposite the one end of the frame disposed toward the at least two wheels.

21. The cart of claim 19, wherein the cart is configured such that the backpack can be normally worn by the person while the frame is attached to the backpack.
